(19) United States
(12) Patent Application Publication
(10) Pub. No.: US 2018/0156319 A1
(43) Pub. Date: Jun. 7, 2018

(54) PLANETARY FRICTION GEAR MECHANISM, METHOD FOR OPERATING A PLANETARY FRICTION GEAR MECHANISM, AND FLUID ENERGY MACHINE

(71) Applicant: Robert Bosch GmbH, Stuttgart (DE)

(72) Inventors: Francois Brusset, Chantilly (FR); Frank Scholz, Stuttgart-Feuerbach (DE)

(21) Appl. No.: 15/829,107

(22) Filed: Dec. 1, 2017

(30) Foreign Application Priority Data
Dec. 5, 2016 (DE) 10 2016 224 123.0

(51) Int. Cl. F16H 13/08; F16H 57/04

(52) U.S. Cl. CPC F16H 13/08; F16H 57/046; F16H 57/0487; F16H 57/0479; F16H 57/0486; F16H 57/0471

(57) ABSTRACT

A planetary friction gear mechanism (10) for a fluid energy machine (1), wherein a gap (24) for supplying lubricant (M) to a thrust collar (20) is formed, at least in sections, between an inner side (21a, 22a) of respective annular elements (21, 22) of the thrust collar (20) and adjacently arranged end sides (16a, 16b) of a plurality of planetary gears (16, 17, 18). Also a method for operating a planetary friction gear mechanism (10), and to a fluid energy machine (1).

### BACKGROUND OF THE INVENTION

The invention relates to a planetary friction gear mechanism for a fluid energy machine. The invention also relates to a method for operating a planetary friction gear mechanism for a fluid energy machine. The invention further relates to a fluid energy machine.

Rising fuel prices and planned legislation concerning the limitation of CO₂ emission have the result that manufacturers of automobiles and internal combustion engines are working more intensely on efficient drives.

The efficiency of the drivetrain can be improved significantly by the use of the exhaust-gas residual heat. This brings about approximately 2.5 to 5% fuel saving. In this case, an exhaust-gas residual-heat recovery system uses the exhaust-gas residual heat of the internal combustion engine in order to produce mechanical energy by way of a thermodynamic steam power process.

A central component of the steam power process is an expansion machine which expands a superheated working medium in vapor state, with an output of work to an expander shaft. Continuous-flow machines, such as for example turbomachines or positive-displacement machines, such as for example piston machines or screw-type machines, are used as expansion machines. Shaft work of the expansion machine is either output to a crankshaft of the motor vehicle via a gear mechanism or drives an electric machine which feeds the electrical energy into an on-board power system.

DE 10 2013 021 251 A1 discloses a fluid energy machine for converting energy from a pressurized fluid into mechanical energy, wherein the fluid machine has a high-pressure port for the supply of the fluid and a low-pressure port for the discharge of the fluid.

### SUMMARY OF THE INVENTION

The present invention provides a planetary friction gear mechanism for a fluid energy machine, having a sun wheel which is fixedly connected to an impeller of the fluid energy machine, having a plurality of planetary gears which are driven by the sun wheel, having a planetary gear carrier for accommodating the plurality of planetary gears and having an internal gear which surrounds the planetary gears, wherein the sun wheel has a thrust collar for supporting an axial force applied by the impeller to the sun wheel during the operation of the fluid energy machine, and wherein a gap for supplying lubricant to the thrust collar is formed, at least in sections, between an inner side of respective annular elements of the thrust collar and adjacently arranged end sides of the plurality of planetary gears.

The present invention also provides a method for operating a planetary friction gear mechanism. The method comprises providing a sun wheel which is fixedly connected to an impeller of the fluid energy machine, providing a plurality of planetary gears which are driven by the sun wheel, providing a planetary gear carrier for accommodating the plurality of planetary gears and providing an internal gear which surrounds the planetary gears.

The method also comprises supporting by means of a thrust collar of the sun wheel an axial force applied by the impeller to the sun wheel during the operation of the fluid energy machine.

The method further comprises supplying lubricant to the thrust collar by means of a gap which is formed, at least in sections, between an inner side of respective annular elements of the thrust collar and adjacently arranged end sides of the plurality of planetary gears.

The present invention further provides a fluid energy machine for converting energy from a pressurized fluid into mechanical energy, comprising an impeller which is able to be acted upon by means of a fluid, and comprising a planetary friction gear mechanism which is connected to the impeller.

One idea of the present invention is to provide higher gear efficiency as a result of reducing friction losses of the planetary friction gear mechanism by providing the gap for supplying lubricant to the thrust collar, which gap is formed, at least in sections, between the inner side of respective annular elements of the thrust collar and adjacently arranged end sides of the plurality of planetary gears. This is advantageously made possible by providing hydrodynamic lubrication in the form of a lubricating film that is arranged between the inner side of respective annular elements of the thrust collar and adjacently arranged end sides of the plurality of planetary gears. The installed components, that is to say the planetary gears, adapted according to the invention, and the correspondingly formed thrust collar, are simple to produce and thus have low production costs.

According to a further preferred refinement, it is provided that the inner side of respective annular elements of the thrust collar, and/or the adjacently arranged end sides of the plurality of planetary gears, is/are of substantially conical form. Consequently, the gap for supplying lubricant to the thrust collar may advantageously be created.

According to a further preferred embodiment, it is provided that a cone angle formed between the inner side of respective annular elements of the thrust collar and the adjacently arranged end sides of the plurality of planetary gears lies in a range from 0.1° to 5°, preferably from 0.5° to 3°. This advantageously allows efficient hydrodynamic lubrication of the thrust collar to be brought about.

According to a further preferred refinement, it is provided that the inner side of respective annular elements of the thrust collar and the adjacently arranged end sides of the plurality of planetary gears form punctiform contact or linear contact. This allows the efficiency to be increased and wear of the respective components to be reduced as a result of reducing the friction of the planetary friction gear mechanism.

According to a further preferred refinement, it is provided that the linear contact is in a plane in which respective axes of the sun wheel and of the plurality of planetary gears are arranged. Consequently, the least possible contact exists in the axial direction between the sun wheel and the plurality of planetary gears.

According to a further preferred refinement, it is provided that the gap for supplying lubricant is formed to converge substantially in the circumferential direction. Consequently, when lubricant is sprayed onto the planetary gears, the lubricant can be transported efficiently into the gap.

According to a further preferred refinement, it is provided that a lubricating film is formed between the inner side of respective annular elements of the thrust collar and the adjacently arranged end sides of the plurality of planetary gears during the operation of the fluid energy machine. Consequently, friction between the sun wheel and the planetary gears in the axial direction of the planetary friction gear mechanism can advantageously be reduced.

According to a further preferred refinement, it is provided that a supply of lubricant to the thrust collar, in particular to the gap formed between the inner side of respective annular elements of the thrust collar and the adjacently arranged end sides of the plurality of planetary gears, takes place via lubricant that is sprayed onto running surfaces of the plurality of planetary gears. This allows an additional or further supply of lubricant to be omitted and, as a result of the spraying-on of the planetary gears by the lubricant, an adequate supply of lubricant to the gap to be ensured.

The described embodiments and refinements may be combined with one another in any desired manner.

Further possible embodiments, refinements and implementations of the invention also encompass combinations, not explicitly mentioned, of features of the invention described above or below with regard to the exemplary embodiments.

### BRIEF DESCRIPTION OF THE DRAWINGS

The appended drawings are intended to convey further understanding of the embodiments of the invention. They illustrate embodiments and serve, in connection with the description, for explaining principles and concepts of the invention.

Other embodiments, and a large number of the stated advantages, will emerge with regard to the drawings. The illustrated elements of the drawings are not necessarily shown to scale with respect to one another.

In the drawings:

FIG. 1a shows a schematic illustration of a planetary friction gear mechanism according to a preferred embodiment of the invention;

FIG. 1b shows a cross-sectional view of a fluid energy machine, having the planetary friction gear mechanism according to the invention, according to the preferred embodiment of the invention;

FIG. 2 shows a schematic illustration of components of the planetary friction gear mechanism according to the preferred embodiment of the invention;

FIG. 3 shows a schematic illustration of a thrust collar of the planetary friction gear mechanism according to the preferred embodiment of the invention;

FIG. 4 shows an enlarged, detailed view of a gap between the thrust collar and a planetary gear of the planetary friction gear mechanism according to the preferred embodiment of the invention;

FIG. 5 shows a schematic illustration of linear contact between the thrust collar and a planetary gear of the planetary friction gear mechanism according to the preferred embodiment of the invention; and

FIG. 6 shows a flow diagram of a method for operating the planetary friction gear mechanism according to the preferred embodiment of the invention.

In the figures of the drawings, the same reference signs are used to denote identical or functionally identical elements, structural parts or components, unless stated otherwise.

### DETAILED DESCRIPTION

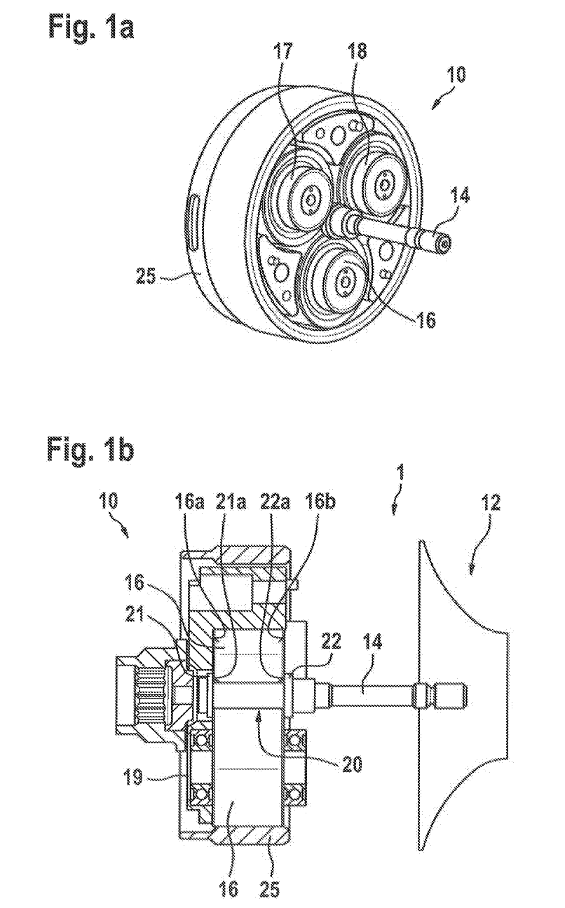

FIG. 1a shows a schematic illustration of a planetary friction gear mechanism according to a preferred embodiment of the invention. The planetary friction gear mechanism 10 for the fluid energy machine (not shown in FIG. 1a) has a sun wheel 14 which is fixedly connected to an impeller (not shown in FIG. 1a) of the fluid energy machine, has a plurality of planetary gears 16, 17, 18 which are driven by the sun wheel 14, has a planetary gear carrier 19 for accommodating the plurality of planetary gears 16, 17, 18 and has an internal gear 25 which surrounds the planetary gears 16, 17, 18.

FIG. 1b shows a cross-sectional view of a fluid energy machine, having the planetary friction gear mechanism according to the invention, according to the preferred embodiment of the invention.

The sun wheel 14 has a thrust collar 20. The thrust collar 20 serves for supporting an axial force applied by the impeller 12 to the sun wheel 14 during the operation of the fluid energy machine 1. A gap (not shown in FIG. 1b) for supplying lubricant to the thrust collar 20 is formed, at least in sections, between an inner side 21a, 22a of respective annular elements 21, 22 of the thrust collar 20 and adjacently arranged end sides 16a, 16b of the plurality of planetary gears 16, 17, 18.

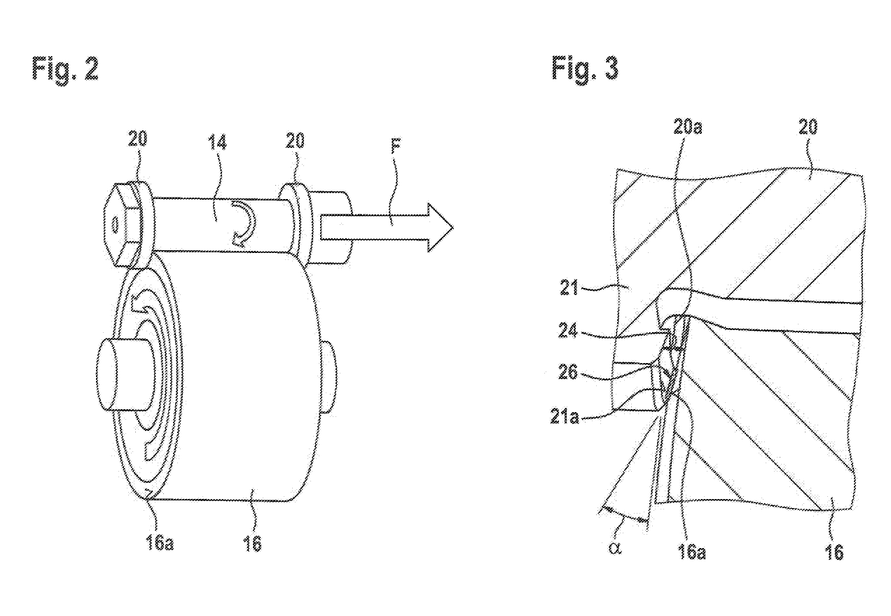

FIG. 2 shows a schematic illustration of components of the planetary friction gear mechanism according to the preferred embodiment of the invention. The sun wheel 14 forms areal frictional contact with the planetary gear 16 in the radial direction of the planetary friction gear mechanism. Furthermore, respective end sides of the planetary gear 16 form frictional contact with the thrust collar 20 in the axial direction of the planetary friction gear mechanism. Said frictional contact is brought about substantially by the axial force F applied by the impeller of the fluid energy machine to the sun wheel 14.

FIG. 3 shows a schematic illustration of a thrust collar of the planetary friction gear mechanism according to the preferred embodiment of the invention.

The inner side 21a of the annular element 21 of the thrust collar 20, and the adjacently arranged end sides 16a of the plurality of planetary gears, of which only the planetary gear 16 is illustrated in FIG. 3, are preferably of substantially conical form. Alternatively, it is possible for the inner sides 21a of respective annular elements 21 of the thrust collar 20, or the adjacently arranged end sides 16a of the plurality of planetary gears 16, to be of substantially conical form, or to have another suitable form which allows reduced friction between the inner sides 21a of respective annular elements 21 of the thrust collar 20 and the adjacently arranged end sides 16a of the plurality of planetary gears 16.

A cone angle α formed between the inner side 21a of respective annular elements 21 of the thrust collar 20 and the adjacently arranged end sides 16a of the plurality of planetary gears 16 preferably lies in a range from 0.1° to 5°, preferably from 0.5° to 3°. The gap 24 for supplying lubricant M is formed to converge substantially in the circumferential direction.

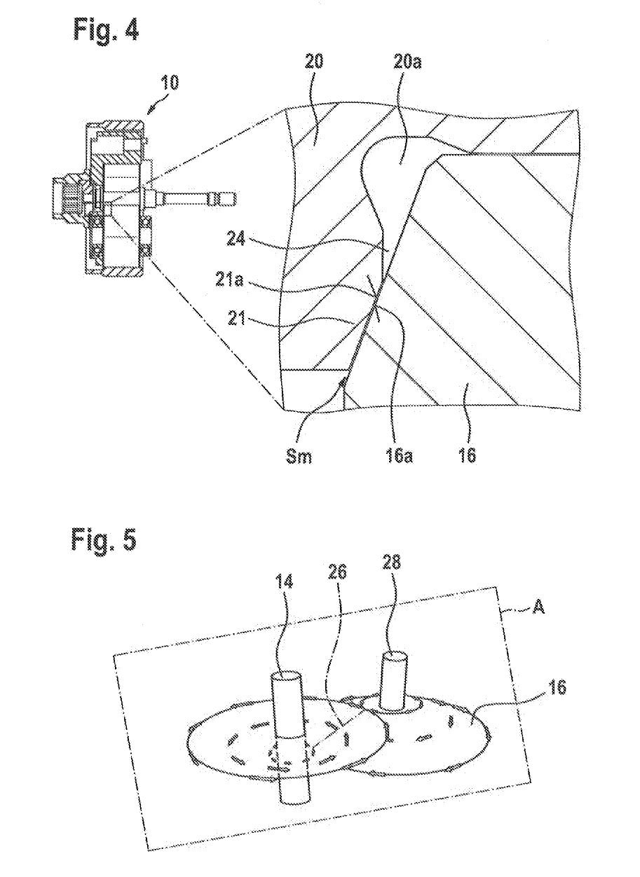

FIG. 4 shows an enlarged, detailed view of a gap between the thrust collar and a planetary gear of the planetary friction gear mechanism according to the preferred embodiment of the invention. A lubricating film is formed between the inner side 21a of respective annular elements 21 of the thrust collar 20 and the adjacently arranged end sides 16a of the plurality of planetary gears 16 during the operation of the fluid energy machine.

A supply of lubricant to the thrust collar 20, in particular to the gap 24 formed between the inner side 21a of respective annular elements 21 of the thrust collar 20 and an adjacently arranged end side 16a of the planetary gear 16, takes place via lubricant M that is sprayed onto running surfaces of the plurality of planetary gears 16. The thrust collar 20 has a recess or a cutout within the gap 24. This advantageously brings about an efficient supply of lubricant to further regions of the thrust collar 20.

FIG. 5 shows a schematic illustration of linear contact between the thrust collar and a planetary gear of the planetary friction gear mechanism according to the preferred embodiment of the invention.

The inner side (not shown in FIG. 5) of respective annular elements of the thrust collar and the adjacently arranged end sides of the plurality of planetary gears preferably form linear contact 26. Alternatively, it is possible for them to form for example punctiform contact. The linear contact 26 is in a plane A in which respective axes 14, 28 of the sun wheel 14 and of the planetary gear 16 or of the plurality of planetary gears are arranged.

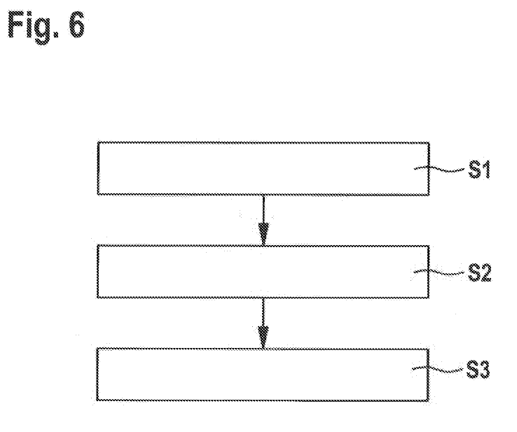

FIG. 6 shows a flow diagram of a method for operating the planetary friction gear mechanism according to the preferred embodiment of the invention.

The method comprises providing (step S1) a sun wheel which is fixedly connected to an impeller of the fluid energy machine, providing a plurality of planetary gears which are driven by the sun wheel, providing a planetary gear carrier for accommodating the plurality of planetary gears and providing an internal gear which surrounds the planetary gears.

The method also comprises supporting (step S2) by means of a thrust collar of the sun wheel an axial force applied by the impeller to the sun wheel during the operation of the fluid energy machine.

The method further comprises supplying (step S3) lubricant to the thrust collar by means of a gap which is formed, at least in sections, between an inner side of respective annular elements of the thrust collar and adjacently arranged end sides of the plurality of planetary gears.

Although the present invention has been described above on the basis of preferred exemplary embodiments, it is not limited thereto but is modifiable in a wide variety of ways. In particular, the invention can be altered or modified in numerous ways without departing from the essence of the invention.

For example, it is possible to modify a shape, a dimension and/or characteristics of the components of the planetary friction gear mechanism.

1. A planetary friction gear mechanism (10) for a fluid energy machine (1), having a sun wheel (14) which is configured to be fixedly connected to an impeller (12) of the fluid energy machine (1), having a plurality of planetary gears (16, 17, 18) which are driven by the sun wheel (14), having a planetary gear carrier (19) for accommodating the plurality of planetary gears (16, 17, 18) and having an internal gear (25) which surrounds the planetary gears (16, 17, 18), wherein the sun wheel (14) has a thrust collar (20) for supporting an axial force (F) applied by the impeller (12) to the sun wheel (14) during operation of the fluid energy machine (1), and wherein a gap (24) for supplying lubricant (M) to the thrust collar (20) is formed, at least in sections, between an inner side (21a, 22a) of respective annular elements (21, 22) of the thrust collar (20) and adjacently arranged end sides (16a, 16b) of the plurality of planetary gears (16, 17, 18).

2. The planetary friction gear mechanism according to claim 1, characterized in that the inner side (21a, 22a) of respective annular elements (21, 22) of the thrust collar (20), and/or the adjacently arranged end sides (16a, 16b) of the plurality of planetary gears (16, 17, 18), is/are of substantially conical form.

3. The planetary friction gear mechanism according to claim 1, characterized in that a cone angle (α) formed between the inner side (21a, 22a) of respective annular elements (21, 22) of the thrust collar (20) and the adjacently arranged end sides (16a, 16b) of the plurality of planetary gears (16, 17, 18) lies in a range from 0.1° to 5°.

4. The planetary friction gear mechanism according to claim 1, characterized in that the inner side (21a, 22a) of respective annular elements (21, 22) of the thrust collar (20) and the adjacently arranged end sides (16a, 16b) of the plurality of planetary gears (16, 17, 18) form punctiform contact or linear contact (26).

5. The planetary friction gear mechanism according to claim 4, characterized in that the linear contact (26) is in a plane (A) in which respective axes of the sun wheel (14) and of the plurality of planetary gears (16, 17, 18) are arranged.

6. The planetary friction gear mechanism according to claim 1, characterized in that the gap (24) for supplying lubricant (M) is formed to converge substantially in a circumferential direction.

7. The planetary friction gear mechanism according to claim 1, characterized in that a lubricating film is formed between the inner side (21a, 22a) of respective annular elements (21, 22) of the thrust collar (20) and the adjacently arranged end sides (16a, 16b) of the plurality of planetary gears (16, 17, 18) during the operation of the fluid energy machine (1).

8. The planetary friction gear mechanism according to claim 1, characterized in that a supply of lubricant to the thrust collar (20) takes place via lubricant (M) that is sprayed onto running surfaces of the plurality of planetary gears (16, 17, 18).

9. A method for operating a planetary friction gear mechanism (10) for a fluid energy machine (1), comprising the steps of:
providing (S1) a sun wheel (14) which is fixedly connected to an impeller (12) of the fluid energy machine (1), providing a plurality of planetary gears (16, 17, 18) which are driven by the sun wheel (14), providing a planetary gear carrier (19) for accommodating the plurality of planetary gears (16, 17, 18) and providing an internal gear (25) which surrounds the planetary gears (16, 17, 18);
supporting (S2) by means of a thrust collar (20) of the sun wheel (14) an axial force (F) applied by the impeller (12) to the sun wheel (14) during the operation of the fluid energy machine (1); and
supplying (S3) lubricant (M) to the thrust collar (20) by means of a gap (24) which is formed, at least in sections, between an inner side (21a, 22a) of respective annular elements (21, 22) of the thrust collar (20) and adjacently arranged end sides (16a, 16b) of the plurality of planetary gears (16, 17, 18).

10. A fluid energy machine (1) for converting energy from a pressurized fluid into mechanical energy, comprising
an impeller (12) which is able to be acted upon by means of a fluid; and
a planetary friction gear mechanism (10) according to claim 1 connected to the impeller (12).

11. The planetary friction gear mechanism according to claim 1, characterized in that a cone angle (α) formed between the inner side (21a, 22a) of respective annular elements (21, 22) of the thrust collar (20) and the adjacently arranged end sides (16a, 16b) of the plurality of planetary gears (16, 17, 18) lies in a range from 0.5° to 3°.

12. The planetary friction gear mechanism according to claim 1, characterized in that a supply of lubricant to the thrust collar (20), to the gap (24) formed between the inner side (21a, 22a) of respective annular elements (21, 22) of the thrust collar (20) and the adjacently arranged end sides (16a, 16b) of the plurality of planetary gears (16, 17, 18), takes place via lubricant (M) that is sprayed onto running surfaces of the plurality of planetary gears (16, 17, 18).
